(19) United States
(12) Patent Application Publication
(10) Pub. No.: US 2023/0254351 A1
(43) Pub. Date: Aug. 10, 2023

(54) BINDING A PHYSICAL WHITEBOARD TO A DIGITAL WHITEBOARD CANVAS AND REPEATEDLY UPDATING THE DIGITAL WHITEBOARD CANVAS BASED ON MANIPULATIONS TO THE PHYSICAL WHITEBOARD

(71) Applicant: Haworth, Inc., Holland, MI (US)

(72) Inventor: Rupen CHANDA, Austin, TX (US)

(73) Assignee: Haworth, Inc., Holland, MI (US)

(21) Appl. No.: 18/106,968

(22) Filed: Feb. 7, 2023

Related U.S. Application Data
(60) Provisional application No. 63/307,938, filed on Feb. 8, 2022.

(51) Int. Cl. H04L 65/401

(52) U.S. Cl. CPC H04L 65/4015

(57) ABSTRACT

System and method for collaboration are disclosed. The method includes, obtaining, by a client device, an image including a code, of at least a portion of a physical whiteboard. The method includes, converting, by at least one of the client device and a server device, at least a portion of the image to an editable representation. The method includes, identifying, by the server device, a virtual workspace, linked to the code. The method includes adding, by the server device, the editable representation of the portion of image to the to the virtual workspace to be provided to one or more client devices participating in the collaboration. The method includes, allowing, by the server device, an edit to the editable representation of the portion of the image, as located in the virtual workspace, the edit being performed by a particular participant using a particular client device.

### PRIORITY APPLICATION

This application claims the benefit of U.S. Provisional Patent Application No. 63/307,938, filed on 8 Feb. 2022, which application is incorporated herein by reference.

### FIELD OF INVENTION

The technology disclosed relates to collaboration systems that enable users to bind a physical whiteboard to a digital whiteboard canvas (a virtual workspace). More specifically, the technology disclosed relates to allowing a user to repeatedly manipulate content on a physical whiteboard that is bound to or associated with a digital whiteboard canvas (a virtual workspace), such that the digital whiteboard canvas is updated each time the content on the physical whiteboard is manipulated.

### INCORPORATION BY REFERENCE

This application incorporates by reference, U.S. Pat. No. 9,479,548 entitled “COLLABORATION SYSTEM WITH WHITEBOARD ACCESS TO GLOBAL COLLABORATION DATA” and issued on Oct. 25, 2016 (Attorney Docket No. HAWT 1008-1).

### BACKGROUND

Collaboration systems are used in a variety of environments to allow users to contribute and participate in content generation and review. Users of collaboration systems can join collaboration meetings (or simply referred to as collaborations) from locations around the world. Some participants of a collaboration may not have access to expensive digital whiteboards or access to computer equipment that allows the participants to connect to, view and manipulate a virtual workspace of the collaboration environment. This can limit the usefulness of collaboration systems as those participants may not be able to participate in collaboration sessions that require a digital whiteboard or a digital whiteboard system.

Therefore, it is desirable to provide a collaboration system that can accommodate users who do not have access to a digital whiteboard or a digital whiteboard system.

### SUMMARY

A system and method for operating a system are provided for collaborating using a virtual workspace. The technology disclosed enables participants using physical whiteboards to participate in a collaboration session in which other participants use computing devices (or network nodes) with digital displays. The method includes obtaining, by a client device, an image, including a code, of at least a portion of a physical whiteboard. The image can be obtained using a mobile computing device, a camera, a scanner, etc. The method includes converting, by at least one of the client device and a server device, at least a portion of the image to an editable representation. The method includes identifying, by the server device, a virtual workspace, linked to the code. The method includes adding, by the server device, the editable representation of the portion of image to the virtual workspace to be provided to one or more client devices participating in the collaboration. The method includes allowing, by the server device, an edit to the editable representation of the portion of the image, as located in the virtual workspace, the edits being performed by a particular participant using a particular client device and the edit being received by one or more client devices participating in the collaboration. The method includes, sending, by the server device, the edited editable representation of the portion of the image, as an edited image, to the client device, which does not have access to directly collaborate on the virtual workspace, along with at least one of the code and an updated code.

The method further comprising, printing, according to an instruction from at least one of the client device and the server device, the edited image along with the at least one of the code and the updated code.

The method further comprising, the client device rendering the edited image along with the at least one of the code and the updated code.

The physical whiteboard is a physical medium on which a user can interact with. Examples of physical whiteboard include a paper of any size, a poster of any size, a whiteboard of any size, a blackboard of any size, any other type of boards or surfaces on which a participant can write using any type of writing instrument.

The physical whiteboard can be an electronic medium on which a user can interact with.

The virtual workspace can include multiple canvases and a canvas of the multiple canvases can be identified in dependence upon the code.

Different types of codes (also referred to as meeting codes) can be used such as a Quick Response (QR) code, a bar code, an identifier, etc. The identifier can be composed of a sequence of letters, numbers, or other types of characters. The identifier can be composed of combinations letters, numbers and/or characters. In one implementation, the virtual workspace is identified by a code which is a nine digit identifier (ID). It is understood that codes of length greater than or less than nine digits can be used without any impact on the collaboration meetings.

In one implementation, the virtual workspace is identified by a uniform resource locator (or a URL) such as “bluescape.io/canvas/<canvasname>”. The URL can identify a storage location at which the canvas is stored. In such an implementation, the code is mapped to a uniform resource locator (or URL) identifying the location at which the virtual workspace linked to the code can be accessed. The code can be used to access the URL which can then be further used to access the location of the virtual workspace linked to the collaboration meeting or the whiteboarding session.

The code can be a bar code. The code can be an alphanumeric string of a pre-defined length such as of length six or more. The code can be a PIN code of a pre-defined length such as of length four, six or eight or more. The code can be an annotation drawn by hand by one or the participants and the server device includes logic to link the hand drawn annotation to the virtual workspace.

In one implementation, the code is created by a user of the client device and is associated with the virtual workspace in dependence upon at least one of a selection made by the user and the server device.

The code can be located at a predefined location on the physical whiteboard. For example, the code can be located at the top left corner or the bottom right corner of the physical whiteboard. It understood that any location on the physical whiteboard can be designated for positioning the code.

In one implementation, the method includes mapping, by the server device, the editable representation of the portion of the image obtained from the physical whiteboard to the virtual workspace linked to the code, such that the mapped editable representation of the portion of the image fits within an area within the virtual workspace.

In one implementation, the method includes detecting, by the server device, a conflict when an edit to the editable representation, as performed by the particular participant, conflicts with an edit made on the physical whiteboard by another participant. The method includes sending, by the server device, a message to the particular participant and the other participant indicating the conflict.

In one implementation, the method includes separately storing, by the server device and as conflicted images, both (i) the editable representation, as edited by the particular participant and (ii) an editable representation as converted from an image obtained from the client device and as edited by the other participant. The method includes updating the virtual workspace linked to the code with a separate editable representation of each of the conflicted images.

In one implementation, the method includes identifying, by the server device, the edits causing the conflict and sending a representation of the identified edits to the particular participant and the other participant.

Systems and computer program products which can be executed using the methods are also described herein.

Other aspects and advantages of the present invention can be seen on review of the drawings, the detailed description and the claims, which follow.

### BRIEF DESCRIPTION OF THE DRAWINGS

The technology will be described with respect to specific embodiments thereof, and reference will be made to the drawings, which are not drawn to scale, and in which:

FIGS. 1A and 1B illustrate example aspects of a digital whiteboarding system also referred to as digital collaboration system or a collaboration system.

FIG. 2 and FIG. 3 presents an example of binding a physical whiteboard to a digital whiteboard canvas (or virtual workspace) and repeatedly updating the digital whiteboard canvas based on manipulations to content on the physical whiteboard.

FIG. 4 illustrates a collaborative whiteboarding session in which at least one participant uses a physical whiteboard to participate in the whiteboarding session.

FIG. 5 presents a flowchart including process operations performed at the server device to bind a physical whiteboard to a digital whiteboard in a collaborative whiteboarding session.

FIGS. 6A, 6B, 6C, 6D, 6E, 6F, 6G and 6H present examples of data structures that can be used to implement a digital whiteboard collaboration system that includes at least one participant using a physical whiteboard.

FIG. 7 is a simplified block diagram of a computer system e.g., a client-side network node that can be used to implement the technology disclosed.

FIG. 8 is a simplified functional block diagram of a client-side network node and display that can be used to implement the technology disclosed.

FIG. 9 is a flowchart illustrating operations of a client-side network node like that of FIG. 8.

### DETAILED DESCRIPTION

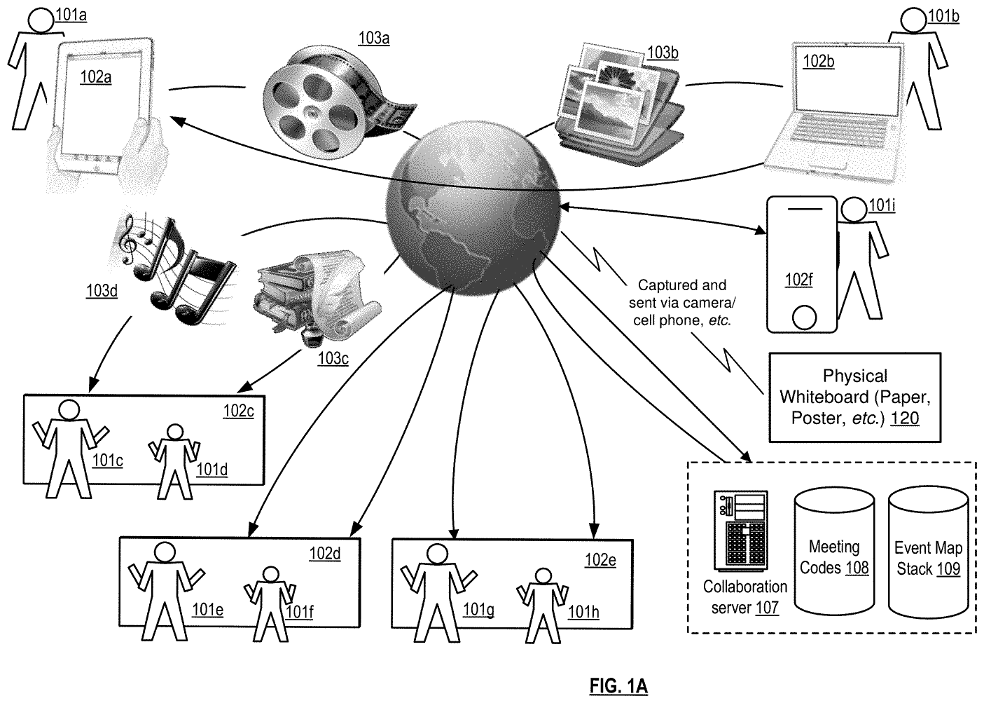

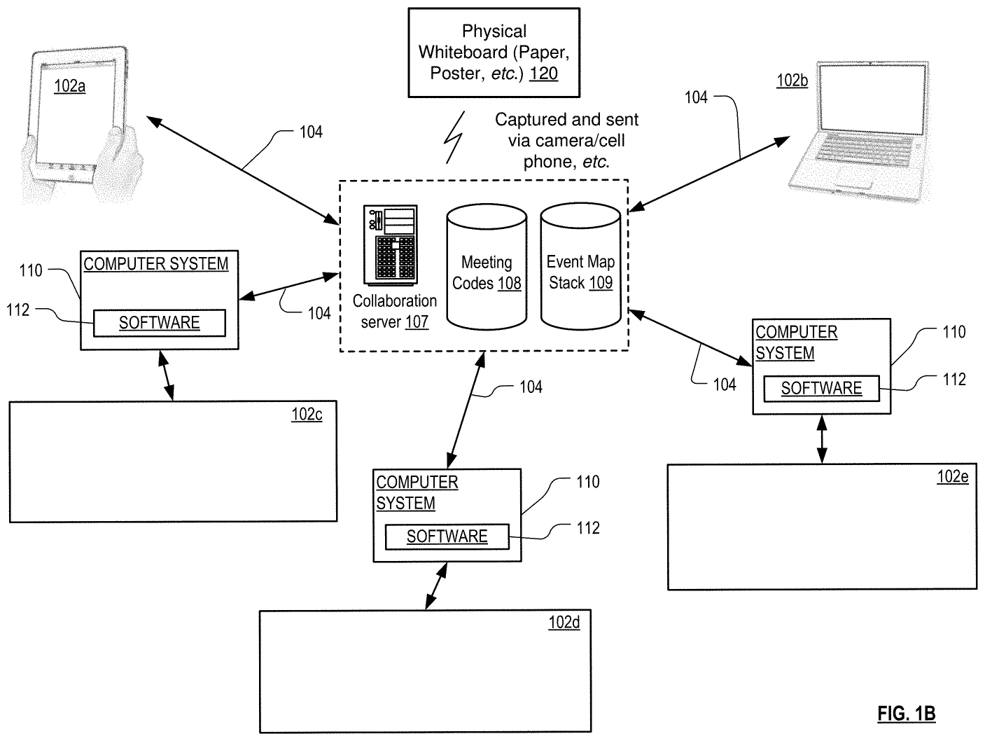

A detailed description of embodiments of the present technology is provided with reference to the FIGS. 1-9.

The following description is presented to enable a person skilled in the art to make and use the technology, and is provided in the context of a particular application and its requirements. Various modifications to the disclosed embodiments will be readily apparent to those skilled in the art, and the general principles defined herein may be applied to other embodiments and applications without departing from the spirit and scope of the present technology. Thus, the present technology is not intended to be limited to the embodiments shown, but is to be accorded the widest scope consistent with the principles and features disclosed herein.

### Environment

We describe a collaboration environment in which users participate in digital whiteboarding sessions or collaboration meetings from network nodes located across the world. A user or a participant can join and participate in the digital whiteboarding session, using display clients, such as browsers, for large format digital displays, desktop and laptop computers, or mobile computing devices. Collaboration systems can be used in a variety of environments to allow users to contribute and participate in content generation and review by accessing a virtual workspace (e.g., a canvas or a digital whiteboard). Users of collaboration systems can join collaboration sessions (or whiteboarding sessions) from remote locations around the globe. Participants of a collaboration meeting can share digital assets such as documents, spreadsheets, slide decks, images, videos, line drawings, annotations, prototype designs, software and hardware designs, user interface designs, etc. with other participants in a shared workspace (also referred to as a virtual workspace or a canvas). Other examples of digital assets include software applications such as third-party software applications or proprietary software applications, web pages, web resources, cloud-based applications, APIs to resources or applications running on servers.

In some collaboration meetings, at least one or more desired participants of the meeting may not have access to a computing device that is capable of accessing the virtual workspace, in which the digital assets in the virtual workspace can be manipulated (e.g., created, edited, moved, deleted, annotated, etc.). Therefore, there is a need for a collaboration system that allows users who do not have access to a digital whiteboard or a digital whiteboard system to interact with digital assets in the virtual workspace, manipulate the digital assets and/or add content to the virtual workspace (or canvas). The technology disclosed provides a collaboration system that allows a user to use a physical whiteboard to interact with other participants in the collaboration session. There are several technological challenges to enable such participants to participate in a collaboration session that uses physical whiteboards. For example, the participants can use different types and sizes of physical whiteboards to participate in a collaboration meeting. Additionally, multiple participants using physical whiteboards along with digital whiteboards can make conflicting hand edits or digital edits. It is also a challenge to link the physical whiteboard to a target virtual workspace (or canvas) for collaboration meeting. Furthermore, there is a technological challenge in allowing the user of the physical whiteboard to continue to actively collaborate after they have made initial edits on their physical whiteboard that are then provided to the collaboration system, e.g., the user of the physical whiteboard may not be able to continue editing the content in an ongoing collaboration meeting after they have provided their initial edits. The technology disclosed herein provides a collaboration system that solves these problems while allowing a participant to use a physical whiteboard.

FIG. 1A illustrates example aspects of a digital collaboration environment. In the example, a plurality of users 101a-i (collectively 101), may desire to collaborate with each other, including sharing digital assets including, for example, complex images, music, video, documents, software programs, prototype designs, user interface designs, software applications and/or other media, all generally designated in FIG. 1A as 103a-d (collectively 103).

The digital assets can be stored in an external system such as a cloud-based storage system or locally within the collaboration system such as on a resource server or a local storage. Throughout this document the term “collaboration system” or “digital whiteboarding system,” encompasses a content collaboration system which can also include a video and/or audio conferencing system that is part of the collaboration system or that is separate from the collaboration system.

The users in the illustrated example can use a variety of devices configured as electronic network nodes, in order to collaborate with each other, for example a tablet 102a, a personal computer (PC) 102b, many large format displays 102c, 102d, 102e and a mobile device 102f (or tablet or camera or other image or data capturing device) (collectively devices 102). The network nodes can be positioned in locations around the world. The user devices, which can be referred to as (client-side) network nodes, have display clients, such as browsers, controlling displays (e.g., a physical display space) on which a displayable area (e.g., a local client screen space) is allocated for displaying graphical objects in a workspace. The displayable area (local client screen space) for a given user may comprise the entire screen of the display (physical display space), a subset of the screen, a window to be displayed on the screen and so on. The display client can set a (client) viewport in the workspace, which identifies an area (e.g., a location and dimensions) in the coordinate system of the workspace, to be rendered in the displayable area (local client screen space). One or more participants can participate in the collaboration session using physical whiteboard 120. The physical whiteboard 120 can be a paper of any size, a poster of any size, a poster board of any size or any other physical medium (e.g., a non-electronic medium) on which the participant can draw, annotate, write, etc. Furthermore, for example, the physical whiteboard can be an electronic medium, such as an electronic tablet or drawing device. The user can draw content on the electronic tablet or drawing device and then capture or obtain an image of the electronic tablet or drawing device. The image can be captured or obtained using another device or the image can be captured or obtained using a screen capture feature of the electronic medium itself (e.g., a screen capture device of the electronic tablet or drawing device). In some cases, a user can take an image or take screen capture of a digital display and then print the image or screen capture on a paper or a poster. The participant can then draw or write on the printed image for further collaboration with other participants. The participant using the physical whiteboard 120 can have access to a device including a camera to capture the image of the physical whiteboard 120. Examples of devices that the participant can use include a scanner, a cell phone or a tablet with a camera, an IP camera, a live streaming camera, a video camera and any other type of sensor that can capture an image of the physical whiteboard 120.

FIG. 1B provides further details of the digital whiteboarding system of FIG. 1A. The display clients, at client-side network nodes, 102a, 102b, 102c, 102d, 102e are in network communication with a collaboration server 107 configured at a server-side network node. A client-side network node can also be referred to as a “client node”, “client device”, or a “digital whiteboard.” The communication between the client-side network nodes and the collaboration server is established using a network(s) 104. The network nodes 102a, 102b, 102c, 102d, and 102e each comprise respective computer systems 110 executing client-side software 112. The collaboration server 107 can maintain participant accounts, by which access to one or more workspace data sets can be controlled. A workspace database 109 (also referred to as event stack map or spatial event map) accessible by the collaboration server 107 can store the workspace data sets, which can comprise spatial event maps. The collaboration server 107 can also establish video conference sessions between the client-side network nodes 102a, 102b, 102c, 102d and 102e for simultaneous video conferencing and virtual workspace collaboration. The meeting codes database 108 stores meeting codes for collaboration meetings. The database can store various types of meeting codes i.e., QR codes, bar codes, alphanumeric strings, annotations, PIN codes, etc. that are mapped to virtual workspaces.

As used herein, a network node is an active electronic device that is attached to a network, and is capable of sending, receiving, or forwarding information over a communications channel. Examples of electronic devices which can be deployed as network nodes, include all varieties of computers, display walls, workstations, laptop and desktop computers, handheld computers and smart phones.

As used herein, the term “database” does not necessarily imply any unity of structure. For example, two or more separate databases, when considered together, still constitute a “database” as that term is used herein.

### Workspace

A collaboration session (or a whiteboarding session) can include access to a data set having a coordinate system establishing a virtual space, termed the “workspace” or “virtual workspace” (or canvas or digital canvas), in which digital assets are assigned coordinates or locations in the virtual space. The workspace can be characterized by a multi-dimensional and in some cases two-dimensional Cartesian plane with essentially unlimited extent in one or more dimensions for example, in such a way that new content can be added to the space, that content can be arranged and rearranged in the space, that a user can navigate from one part of the space to another. The workspace can also be referred to as a “container” in the sense it is a data structure that can contain other data structures or links to other objects or data structures. In one implementation, a workspace is also referred to as a “canvas”. In one implementation, a workspace may contain two or more than two canvases. The canvases in a workspace can comprise of non-overlapping regions. Two or more canvases may also partially overlap each other. Each canvas can in turn include digital assets. If there are multiple canvases in a workspace, a participant may participate in one or more than one canvases in a collaboration (or a whiteboarding) session. In some cases, the canvases may be assigned to groups of participants who collaboratively work on a canvas. In the implementation in which there are multiple canvases in a workspace, the server may assign a separate code to each canvas in the workspace. In such case, a two-part code may be generated for printing on the physical whiteboard may comprise of two parts, a first part identifying a workspace and a second part identifying a canvas, i.e., <workspace identifier>-<canvas identifier>. However, a one-part or a single code may also be generated by the server device (or server-side network node) for a canvas as described above. Further, the code can include information that can be utilized to determine and/or identify a location in the virtual workspace or canvas where the contents of the physical whiteboard should be placed as digital assets. Alternatively, the system can determine where to place contents without the use of the code, but rather based on some other criteria.

### Viewport

Display clients at participant client network nodes in the whiteboarding session can display a portion, or mapped area, of the workspace, where locations on the display are mapped to locations in the workspace. A mapped area, also known as a viewport within the workspace is rendered on a physical screen space (e.g., a local client screen space). Because the entire workspace is addressable in for example Cartesian coordinates, any portion of the workspace that a user may be viewing itself has a location, width, and height in Cartesian space. It is understood that the technology disclosed can use any coordinate system for locating digital assets in a workspace. For example, the technology disclosed can use Cartesian coordinate system, Polar coordinate system or any other system to determine position of digital assets or other types of objects in the workspace. The concept of a portion of a workspace can be referred to as a “viewport” or “client viewport”. The coordinates of the viewport are mapped to the coordinates of the screen space (e.g., the local client screen space) on the display client which can apply appropriate zoom levels based on the relative size of the viewport and the size of the screen space. The coordinates of the viewport can be changed which can change the objects contained within the viewport, and the change would be rendered on the screen space of the display client. Details of the workspace and the viewport are presented in our U.S. Pat. No. 11,126,325 (Atty. Docket No. HAWT 1025-1), entitled, “Virtual Workspace Including Shared Viewport Markers in a Collaboration System,” filed 23 Oct. 2017, which is incorporated by reference as if fully set forth herein.

### Spatial Event Map

Using a virtually unlimited workspace introduces a need to track how people and devices interact with the workspace over time. This can be achieved using a “spatial event map”. The spatial event map contains information needed to define objects and events in the workspace. It is useful to consider the technology from the point of view of space, events, maps of events in the space, and access to the space by multiple users, including multiple simultaneous users. The spatial event map contains information to define digital assets and events in a workspace. The spatial event map can include events comprising data specifying virtual coordinates of location within the workspace at which an interaction with the workspace is detected, data specifying a type of interaction, a digital asset associated with the interaction, and a time of the interaction.

The spatial event map contains and/or identifies content in the workspace for a given whiteboarding or collaboration session. The spatial event map defines arrangement of digital assets (or objects) on the workspace. The spatial event map contains information needed to define digital assets, their locations, and events in the workspace. The collaboration system maps portions of workspace to a digital display e.g., a touch enabled display using the spatial event map. Further details of the workspace and the spatial event map are presented in U.S. Pat. No. US 10,304,037 (Atty. Docket No. HAWT 1011-2), entitled, “Collaboration System Including a Spatial Event Map,” filed Nov. 26, 2013, which is incorporated by reference as if fully set forth herein.

### Events

Interactions with the workspace are handled as events. People, via tangible user interface devices, and systems can interact with the workspace. Events have data that can define or point to a target graphical object (such as a digital asset) to be displayed on a physical display, and an action as creation, modification, movement within the workspace and deletion of a target graphical object (digital asset), and metadata associated with them. Metadata can include information such as originator, date, time, location in the workspace, event type, security information, and other metadata.

Tracking events in a workspace enables the system to not only present the events in a workspace in its current state, but to also share the events with multiple users on multiple displays, to share relevant external information that may pertain to the content, and understand how the spatial data evolves over time. Also, the spatial event map can have a reasonable size in terms of the amount of data needed, while also defining an unbounded workspace.

There can be several different kinds of events in the system. Events can be classified as persistent events, also referred to as history events, that are stored permanently, or for a length of time required by the system for maintaining a workspace during its useful life. Events can be classified as ephemeral events that are useful or of interest for only a short time and shared live among other clients involved in the session. Persistent events may include history events stored in an undo/playback event stream, which event stream can be the same as or derived from the spatial event map of a session. Ephemeral events may include events not stored in an undo/playback event stream for the system. A spatial event map, or maps, can be used by a collaboration system to track the times and locations in the workspace in some implementations of both persistent and ephemeral events on workspaces in the system.

Content or digital assets identified from the physical whiteboard can also be associated with events. Edits or changes to content on the physical whiteboard and edits or changes to digital assets brought into the virtual workspace from the physical whiteboard can be associated and/or identified with or as events. The following discussion provides further details of the technology disclosed with reference to FIG. 1B.

FIG. 1B illustrates the same environment as in FIG. 1A. The application running at the collaboration server 107 can be hosted using Web server software such as Apache or nginx. It can be hosted for example on virtual machines running operating systems such as LINUX. The architecture can involve systems of many computers, each running server applications, as is typical for large-scale cloud-based services. The collaboration server 107 can include or can be in communication with a server and authorization engine that includes communication modules which can be configured for various types of communication channels, including more than one channel for each client (e.g., network node) in a collaboration session. For example, using near-real-time updates across the network, client software 112 can communicate with the communication modules via using a message-based channel, based for example on the Web Socket protocol. For file uploads as well as receiving initial large volume workspace data, the client software 112 can communicate with a server communication module of, for example, the collaboration server 107, via HTTP. The server and authorization engine can run front-end programs written for example in JavaScript and HTML using Node.js, support authentication/authorization based for example on OAuth, and support coordination among multiple distributed clients (e.g., network nodes). The front-end programs can be written using other programming languages and web-application frameworks such as in JavaScript served by Ruby-on-Rails. The server communication module can include a message-based communication protocol stack, such as a Web Socket application, that performs the functions of recording user actions in workspace data (e.g., a spatial event map), and relaying user actions to other clients (e.g., network nodes) as applicable. Parts of the video conferencing and collaboration system can run on a node.JS platform for example, or on other server technologies designed to handle high-load socket applications.

The collaboration server 107 can include or can be in communication with a federated authorization engine can include an OAuth storage database to store access tokens providing access to the digital assets. As mentioned above, the event map stack database 109 includes a workspace data set (e.g., a spatial event map) including events in the collaboration workspace and digital assets, such as graphical objects, distributed at virtual coordinates in the virtual workspace. Examples of digital assets are presented above in the description of FIG. 1A, such as images, music, video, documents, application windows and/or other media. Other types of digital assets, such as graphical objects can also exist on the workspace such as annotations, comments, and text entered by the users. The meeting codes database 108 stores meeting codes for collaboration meetings. The database can store various types of meeting codes i.e., QR codes, bar codes, alphanumeric strings, annotations, PIN codes, etc. Further details of meeting codes are presented below.

### Binding a Physical Whiteboard to a Digital Whiteboard in Collaboration Meetings

The technology disclosed includes logic to bind a physical whiteboard (such as a paper, a poster, etc.) to a digital whiteboard (e.g., a virtual workspace, a canvas of a virtual workspace, etc.) to enable collaboration between participants of a collaboration meeting (or whiteboarding session) even when some participants do not have access to a digital whiteboard. The technology disclosed includes a server-side network node (or server device) and one or more client-side network nodes (or client devices). The server-side network node is configured with logic to take as input, content, from a physical whiteboard and automatically process the content to display it on a virtual workspace or canvas on a digital whiteboard. The image of the content on the physical whiteboard can be captured by a camera, scanner, etc. of a client device. The client device can also capture a code displayed on the physical whiteboard. The code can be used to identify a particular workspace or a particular canvas in the digital whiteboarding session to which the content from the physical whiteboard is to be sent. The technology disclosed includes logic, which resides on a server device or the client device, to convert content captured or obtained from a physical whiteboard to digital format in editable representation. The editable representation can be rendered on the client device after the content (image) is captured. The editable representation can also be rendered on other client devices that have access to a digital whiteboard for collaboration.

Along with receiving or obtaining the captured content (image), the server device of the digital whiteboarding system can receive or obtain the code and it can identify the virtual workspace or canvas linked to the code. The server device includes logic to apply mapping to map the editable representation of the captured content captured from the physical whiteboard to the canvas linked to the code. The mapping ensures that content captured from different sizes of physical whiteboards, papers, posters, etc. fits to a portion of the virtual workspace or canvas for rendering on a client node or client device (e.g., rendered on digital whiteboard or a display of the client node). Information related to the code or information stored elsewhere can be used to determine a location within the canvas or virtual workspace to place the editable representation of the captured content as a digital asset. Similarly, when content from the virtual workspace or canvas that is linked to the physical whiteboard is moved or edited, the system includes logic to apply mapping so that the content fits on a target physical whiteboard such as a paper or a poster, etc. The server device, after obtaining the editable representation (an editable digital asset), can add the editable representation to the canvas of a workspace, as accessed by one or more digital whiteboards participating in the collaboration. Further, the server device allows edits to be made to the editable representation of the image, as located in the canvas. The edits can be received/viewed by participants of the collaboration via one or more digital whiteboards connected to, for example, other client devices. This can be done using the spatial even map technology described herein. Further, the server device can send the edited editable representation of the image, as an edited image, back to the client device (which is not a digital whiteboard or is not a device that has access to directly collaborate on the virtual workspace or canvas). The client device or the servicer device can cause the edited image to be printed (or displayed on a device) along with the code or the updated code. The participant who was using the physical whiteboard can now use the newly printed and edited image to make further edits and the above-described process can be performed all over again (e.g., the capturing, the converting, the identifying, the adding of the image to the canvas, the allowing of the editing of the image, the sending of the edited image to the client device and the printing can be performed again). This cycle can continue until the collaboration is completed.

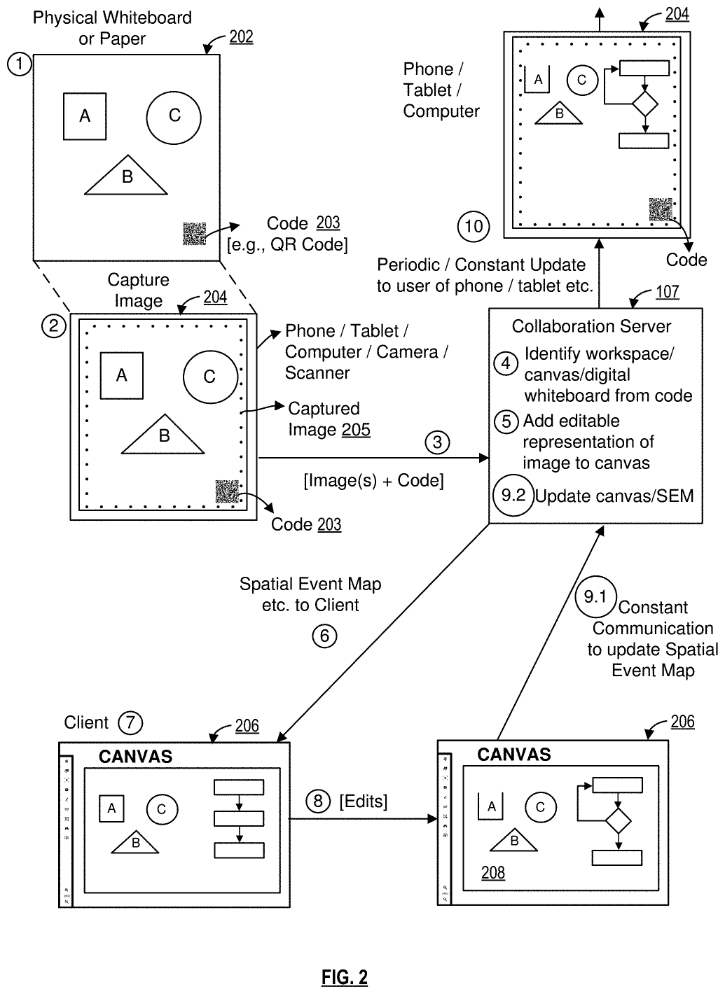

FIGS. 2 and 3 present a round trip process in which content from a physical whiteboard is captured using a camera and processed by a collaboration server (e.g., server device) for placement in a canvas (or a virtual workspace) that is viewed by participants of the collaboration using various types of client nodes (or client devices). The content can be edited in the canvas by a participant and sent back to the client device (that does not have access to directly collaborate on the virtual workspace or canvas) to be printed on as a physical whiteboard along with the code or updated code for further collaboration. The participant using the physical whiteboard can further hand-edit the content on the physical whiteboard. The participant using the physical whiteboard can also use computer programs to edit the content and then print out the further edited content as the physical whiteboard. This process can continue, thus enabling participants using physical whiteboards and digital whiteboards to collaborate and edit content in a collaboration meeting.

FIG. 2 presents a physical whiteboard 202. The physical whiteboard can be a paper, a poster or another physical medium on which a participant of a collaboration session can write or edit content. The contents of the physical whiteboard 202 can be hand drawn or they can be electronically created using various devices and then printed to the physical medium. Different sizes of papers, posters or whiteboards can be used without impacting the collaboration session. The process operations are labeled 1 through 10 in FIG. 2. A participant can add content to a physical whiteboard 202 such as a square labeled “A”, a triangle labeled “B”, and a circle labeled “C” as shown on the physical whiteboard 202 (operation “1”). A code 203 can be included on the physical whiteboard. Different types of codes can be used such as a Quick Response (QR) code, a bar code, an identifier, etc. The code or the identifier can be composed of a sequence of letters, numbers, or other types of characters. The identifier can be composed of combinations letters, numbers and/or characters. The code can identify a virtual workspace, a canvas that is linked to a virtual workspace and/or a digital whiteboard of a collaboration meeting. The code can be printed on the physical whiteboard or it can be projected on the whiteboard using a projection system while the physical whiteboard is captured. Further the code can be an ID PIN for a workspace such as a four digit ID, 8 digit ID, etc. The code 203 can also be an annotation such as a shape drawn by hand by the participant on a particular location on the physical whiteboard. For example, in one instance, the annotation on the left top portion or the right bottom portion is processed as a code by the server when content from the physical whiteboard is received for the first time in whiteboarding session. This code is then matched with annotations previously stored in the collaboration database to match the content from the physical whiteboard to a workspace with which the annotation is linked. In one instance, the user can select a workspace with which a particular code or annotation is to be associated when the whiteboarding session is initiated or prior to start of the whiteboarding session. With such an implementation, a participant can do whiteboarding on a physical whiteboard, and write their PIN (or any other type of code or annotation), which can be captured/scanned by a client device so that the image can be sent to the target whiteboard/canvas. In one implementation, the collaboration server sends a code to the participant who wishes to use a physical whiteboard during a collaboration session. The participant can receive the code via a text message, an email, a WhatsApp™ message or another software application or app installed on participant's mobile device. The participant can print the code and paste it on the physical whiteboard at any location. In one instance, the participant pastes the code on a designated (system designated or user designated) position (a predefined location) on the physical whiteboard such as on the top left corner or bottom right corner, etc.

A client device (e.g., a cell phone, a tablet device, a computer, a camera, etc.) 204 can be used to capture the image of the physical whiteboard as shown in operation “2”. As noted, the image can be captured using other types of devices such as a tablet, a camera, a scanner, etc. Various types of cameras such as video cameras, IP cameras, streaming cameras or other types of sensors can be used to capture the image of the physical whiteboard. In one implementation, a participant can create content using a computer software program running on a computer such as a desktop or a laptop computer. The participant can take a screen capture of the content. The code 203 (such as the QR code or another type of code) can be added to the captured screen image. The captured image 205 is shown in a dotted boundary on the client device 204. The code 203 is also included in the captured image. The captured image including the code 203 is then sent to the collaboration server (e.g., server device) 107 (operation “3”). The collaboration server 107 is described above and performs operations described throughout this document to carry out a collaboration session. The collaboration server 107 can identify the workspace, a digital whiteboard and/or the canvas of the workspace from the code included in data received from the client device 204 (operation “4”). The collaboration server 107 includes logic to convert the images received from the physical whiteboard to an editable representation (e.g., a digital asset) for rendering (operation “5”). The collaboration server 107 can add the editable image(s) and/or data associated with the editable image(s) to the Spatial Event Map. The Spatial Event Map along with additional information is sent to one or more clients connected to the collaboration server and participating in the collaboration session (operation “6”). The one or more clients can then render and edit the editable image(s) that are based on the original image from the physical whiteboard 202.

Upon receiving the Spatial Event Map and/or addition information, the client computing device (client node) displays the editable digital image (digital asset) on a physical display (e.g., a digital whiteboard) 206 connected to the client computing device (operation “7”). A participant of the collaboration session can make edits to the content rendered within a canvas as displayed on the physical display 206 (operation “8”). For example, it can be seen in FIG. 2 that the participant, viewing the canvas has removed a top edge of the square “A” to convert it to a bucket and the participant removed one block from a flowchart and added a decision block to the flowchart, along with an additional connector in the flowchart as shown in the image labeled 208 (updated content 208) on the canvas. The updates to the canvas as displayed on the physical display 206 are periodically communicated from the client computing device to the collaboration server 107 (operation “9.1”). Further, the collaboration server 107 updates the Spatial Event Map and/or additional information stored therein and provides the updated Spatial Event Map and/or additional information to other participants (i.e., other client devices) of the collaboration session that have access to the workspace (operation “9.2”) The collaboration server 107, similar to operation “9.2”, periodically updates the client device 204 with updated content from the canvas (operation “10”). The next operation steps in the process are presented below with reference to FIG. 3.

FIG. 3 presents operation steps that continue the process presented above with reference to FIG. 2. The operations are labeled 10 through 20 in FIG. 3. The updated content (image(s)) from the collaboration server 107 is periodically updated and is provided to the client device 204 (operation “10”). The updated content can be provided to multiple client devices 204, as well, so that multiple participants that do not have access to directly collaborate on the virtual workspace or canvas can participate in the collaboration. The multiple clients 204 can perform the operations describe with respect to FIGS. 2 and 3. It can be seen that the image displayed on the client device 204 on the top right corner of FIG. 3 includes the updated content 208, including edits to the canvas that were made by a participant. The participant who is using the physical whiteboard (or the collaboration server 107) can provide instructions for printing the updated content 208 of the canvas (operation “11”). For example, the client device 204 can print the updated content 208 itself using a local or connected printing device or the collaboration server 107 can instruct printing devices to print the updated content 208. The updated content 208 can be printed on the physical whiteboard 214 or on a paper, poster, etc. including the code 203 (such as the QR code) (or an updated code that is received from the collaboration server 107 or that is generated by the client device 204 itself) which links the physical whiteboard 214 to the canvas. The participant of collaboration session can hand edit (or computer edit) the content on the physical whiteboard (operation “12”). Updated content is shown on physical whiteboard 216, in which an oval has been added with the text “XYZ” by the participant. The participant can take an image of the updated content using the client device 204 (operation “13”).

In a similar manner to that discussed above with reference to FIG. 2, the captured image 218 is then sent to the collaboration server 107 (operation “14”). The captured image 218 includes the code 203 (such as the QR code) to link the captured image 218 to the canvas associated with the collaboration session. The collaboration server 107 can use the code 203 to identify the canvas to which the updated content 208 is added (operation “15”). The collaboration server 107 can add the editable representation of the image to the canvas (operation “16”). The editable representation of the image can be sent to identified canvas 206 (operation “17”) in Spatial Event Map. The image is rendered on the canvas that is displayed on the physical display 206 of the client node (operation “18”). A participant of the collaboration session can edit contents displayed in the canvas (operation “19”). For example, as illustrated, an additional arrow is added to the flowchart and the letter “Y” is removed from the oval. The updated content is located in the canvas, as shown in the illustration 222 and as displayed on the physical display 206. The client device can periodically send updates to content of the canvas to the collaboration server 107 (operation “20”). The process thus continues until the end of the collaboration session. Therefore, as presented above, the technology disclosed enables participants with physical whiteboards (i.e., without expensive digital whiteboards) to collaborate with participants collaborating using a virtual workspace or canvas in a collaboration meeting.

The technology disclosed includes logic to handle conflicts in edits to the same content on two or more physical whiteboards in parallel or conflicts in edits made using a digital whiteboard and a physical whiteboard. For example, consider two participants in a collaboration meeting, a first participant who is using a physical whiteboard and a second participant who is using a digital whiteboard or a physical whiteboard during a collaboration session. Suppose both the first participant and the second participant make edits to the content on their respective physical/digital whiteboards. When the first participant and the second participant upload their respective content to the collaboration server, the server can detect edits from both participants. If a conflict is detected (e.g., the first participant replaces the “A” within the bucket with a “D” and the second participant replaces the “A” within the bucket with an “E”), the system can then provide a first option to the participants in which they can keep their respective copies of the content separately in the canvas. If the participants select this option (or if the system dictates this option), then the system can keep their copies separately in the canvas and display the two copies on the canvas in the digital whiteboard. The system can also present (or dictate) a second option to the participants in which they can merge their respective changes to the content to resolve the conflict (e.g., the bucket includes both the “D” added by the first participant and the “E” added by the second participant). The participants can be given the option to make edits to their changes to resolve the conflict. The collaboration server 107 can merge the two copies of the images from the respective participants when displaying the content on the canvas displayed on the digital whiteboard. This conflict resolution can be carried out in other ways that would be known to a person skilled in the art. For example, in one implementation, the technology disclosed can resolve conflicts by giving priority to edits performed by the participant who is using a physical whiteboard. In another implementation, the participant at a higher position in the organization (e.g., higher job position or higher security level) is given priority when resolving conflicts. For example, a manager's edits are given priority when the edits conflict with edits performed by another participant who is not a manager.

FIG. 4 presents an illustration of a whiteboarding session in which participants collaborate using large format displays (102c and 102d), a mobile device 102f and a laptop computer 102b. However, the participant using the laptop computer 102b is not able to contribute, for some reason, to the whiteboarding session using the laptop computer. The participant may have selected the option to not contribute to the whiteboarding session from the laptop computer 102b by choice or there may be an issue with input devices of the laptop computer 102b that is not allowing the computing device 102b to receive any input from the participant. The technology disclosed allows participants to participate in the whiteboarding session even when they cannot provide their inputs via a computing device. Therefore, the participant, using the laptop computer 102b, prints the canvas or the workspace using a printer 401 and posts it on the physical whiteboard 120. In one implementation, the collaboration server 107 causes the printer 401 to print only the code 203. The participant can paste the printed code on physical whiteboard. When the participant completes her content creation on the physical whiteboard 120, she can capture an image of the physical whiteboard 120 and send it to the collaboration server 107 via an email message or upload via a cloud-based storage server or uploaded via an app on a mobile device. The server includes the logic to process the received image to identify the target virtual workspace (or canvas) using the code. Suppose the code matches the workspace labeled as “workspace A”. The collaboration server then sends the content from the physical whiteboard to the target workspace, i.e., workspace A. Prior to sending the content to the workspace, the server converts the content received from the physical whiteboard 120 to an editable format. In one implementation, the client device includes the logic to convert the content from the image to editable format. The client device then sends this image in editable format to the server device for further processing.

### Process for Binding a Physical Whiteboard to Digital Whiteboards

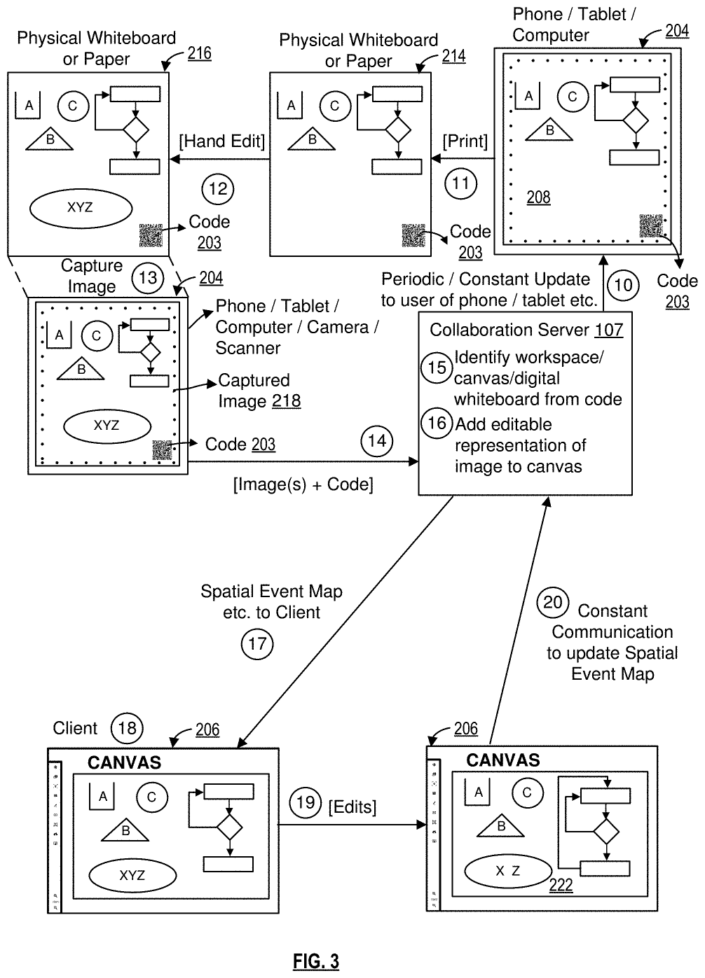

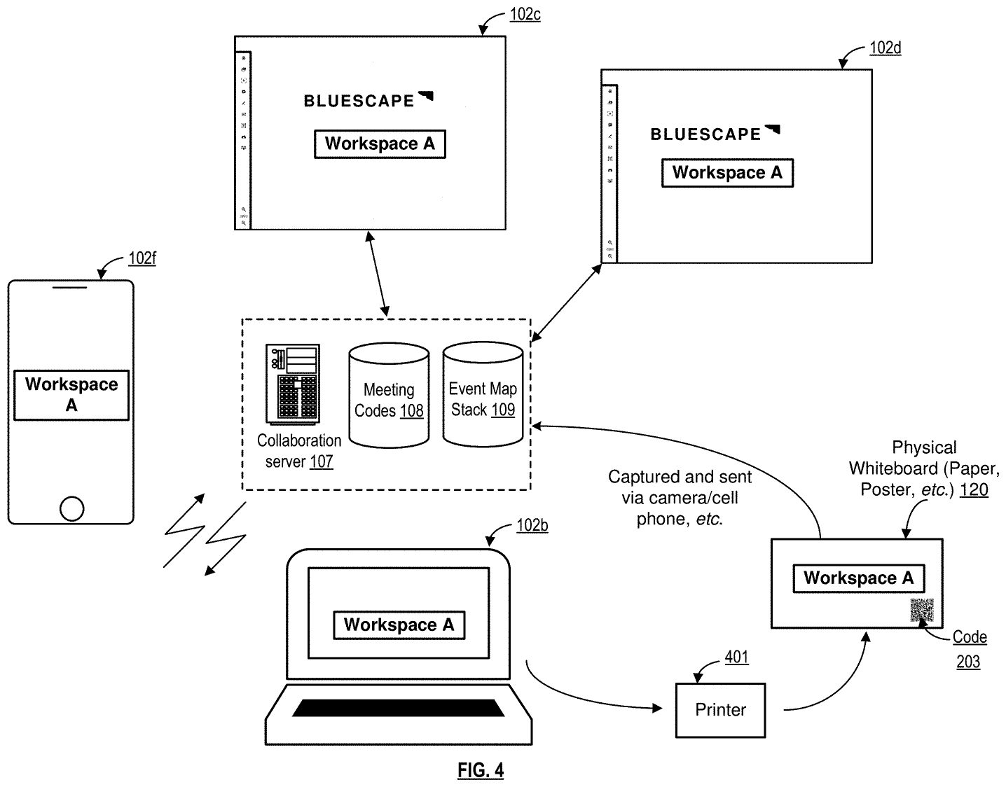

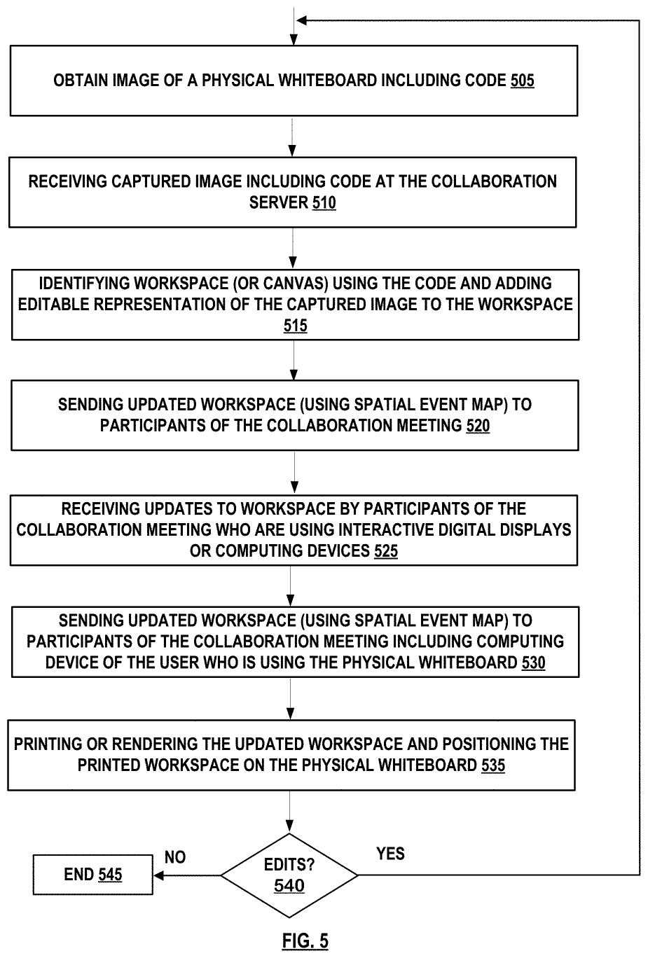

FIG. 5 presents a process flowchart for binding a physical whiteboard to digital whiteboards in a collaboration meeting or a digital whiteboarding meeting. The flowchart illustrates logic executed by collaboration server running on server device. The logic can be implemented using processors programmed using computer programs stored in memory accessible to the computer systems and executable by the processors, by dedicated logic hardware, including field programmable integrated circuits, and by combinations of dedicated logic hardware and computer programs. As with all flowcharts herein, it will be appreciated that many of the operations can be combined, performed in parallel or performed in a different sequence without affecting the functions achieved. In some cases, as the reader will appreciate, a re-arrangement of operations will achieve the same results only if certain other changes are made as well. In other cases, as the reader will appreciate, a re-arrangement of operations will achieve the same results only if certain conditions are satisfied. Furthermore, it will be appreciated that the flow charts herein show only operations that are pertinent to an understanding of the technology, and it will be understood that numerous additional operations for accomplishing other functions can be performed before, after and between those shown.

FIG. 5 presents operations performed at the server to process content received or obtained from the physical whiteboard and send that content to a target canvas (or workspace). Some operations such as capturing an image of the physical whiteboard are carried out at the client-side. The operation 505 includes capturing or obtaining an image of the physical whiteboard including the code such as the QR code, bar code, alphanumeric code, PIN code, annotation, etc. The image is then sent to the collaboration server 107 via an email message, an application or some other medium. The participant can use a cell phone device or another type of computing device to send the image to the collaboration server 107. The image can be captured using any type of camera or a scanner as described above.

The collaboration server 107 receives the image of the physical whiteboard including the code (operation 510). The collaboration server 107 uses the code in the image to identify the target workspace to which the content from the image is to be sent. The collaboration server 107 (and/or the client node) converts the image to an editable format and sends the content in the editable format to the target workspace. If the workspace is empty and/or the content in the image does not match to any existing digital assets in the target workspace, then the server can position the content from the image at any location in the target workspace. In one implementation, the content can be marked indicating that it is received from the physical whiteboard. An identifier of the participant can also be included to indicate that this participant is using the physical whiteboard and has sent this content from the physical whiteboard. When the target workspace already includes digital assets that match at least one of the shapes drawn by the participant on the physical whiteboard then the collaboration server places the content from the physical whiteboard at a location that matches the corresponding digital asset(s) in the target workspace. In this way, the participant who is using the physical whiteboard can edit digital assets using the physical whiteboard.

At an operation 520, the collaboration server 107 sends the updated workspace to computing devices of participants of the whiteboarding session. As described earlier, the collaboration server sends an update to the spatial event map on computing devices of the participants. The computing devices then render the updates to the workspace on their displays thus allowing the participants to view the content provided by the participant who is using the physical whiteboard.

Further edits can be made to the same digital assets by participants who are using computing devices with digital displays to participate in the meeting. The participants can also include new digital assets in the workspace or make annotations, etc. (operation 525). These updates are then sent to the collaboration server 107 as events such as create events, update events, delete events, move events, etc.

The collaboration server 107 can then send the updated workspace to participants of the whiteboarding session (operation 530). The workspace is updated on client devices of all participants including the participant who is using the physical whiteboard. In one instance, the participant who is using the physical whiteboard may be sent the updated workspace via an email or some other electronic medium. The participant can then open the email and print the workspace (or the relevant portion of the workspace) using a printer (operation 535). Rather than printing, the participant can render the received portion of the workspace on their device, without actually accessing the virtual workspace for collaboration. The participant can then make further edits to the printed workspace on the physical whiteboard. If the participant using the physical whiteboard makes further edits to the workspace on the physical whiteboard (operation 540), then the process continues at an operation 505. Otherwise, the collaboration process ends (operation 545).

### Workspace Data Structures

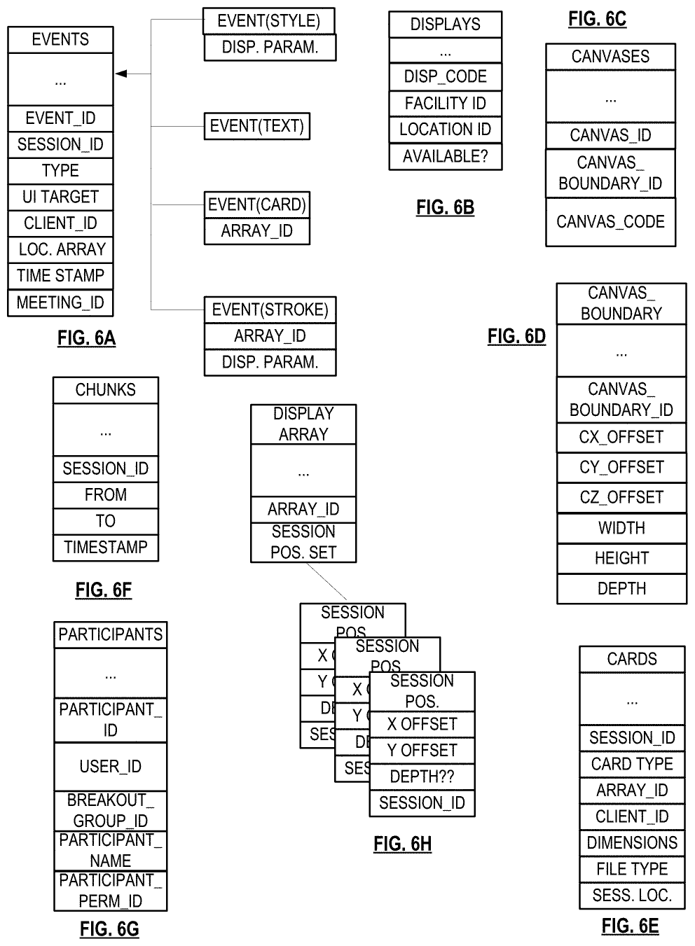

FIGS. 6A-6H represent data structures which can be part of workspace data maintained by a database at the collaboration server 107.

In FIG. 6A, an events data structure is illustrated. An event is an interaction with the workspace that can result in a change in workspace data. An event can include an event identifier, and a meeting identifier. Other attributes that can be stored in the events data structure can include a user identifier, a timestamp, a session identifier, an event type parameter, the client identifier, and an array of locations in the workspace, which can include one or more locations for the corresponding event. It is desirable for example that the timestamp have resolution on the order of milliseconds or even finer resolution, in order to minimize the possibility of race conditions for competing events affecting a single object. Also, the event data structure can include a UI target (or digital asset), which identifies an object in the workspace data to which a stroke on a touchscreen at a client display is linked. Events can be generated when an operation is performed on a digital asset, for example, creation of a digital asset, movement of a digital asset, resizing of a digital asset, deletion of a digital asset, etc. Events can include style events, which indicate the display parameters of a stroke for example. The events can include a text type event, which indicates entry, modification, or movement in the workspace of a text object. The events can include a card type event, which indicates the creation, modification, or movement in the workspace of a card type object. The events can include a stroke type event which identifies a location array for the stroke, and display parameters for the stroke, such as colors and line widths for example. Note that additional properties of events can be recorded by the technology disclosed. The elements of the events data structure shown in FIG. 6A are shown as an example.

Events can be classified as persistent, history events and as ephemeral events. Processing of the events for addition to workspace data, and sharing among users can be dependent on the classification of the event. This classification can be inherent in the event type parameter, or an additional flag or field can be used in the event data structure to indicate the classification.

Basic Message Format

// server <-- client [client-id, “he”, target-id, event-type, event-properties]
client-id - - (string) the ID of the originating client
target-id - - (string) the ID of the target object/widget/app to which this
event is relevant
event-type - - (string) an arbitrary event type
properties - - (object) a JSON object describing pertinent key / values for
the event.
// server --> client[client-id, “he”, target-id, event-id, event-type,
event-properties]
client-id - - (string) the ID of the originating client
target-id - - (string) the ID of the target window to which this event is
relevant
event-id - - (string) the ID of the event in the database
event-type - - (string) an arbitrary event type
properties - - (object) a JSON object describing pertinent key / values for
the event.
// server−> client format of ′he′ is: [<clientId>, <messageType>,
<targetId>, <eventId>,
Note:
The eventId will also be included in history that is fetched via the HTTP API.

History events by Object/Application type

```
Session
  Create - - Add a note or image on the work session
  stroke - - Add a pen or eraser stroke on the background
Note
  text - - Sets or update the text and/or text formatting of a note.
  delete - - Remove the note from the work session
  position - - Update the size or location of the note in the work session
  pin - - Pin or unpin the note
  stroke - - Add a pen or eraser stroke on top of the image
Image
  delete - - Remove the note from the work session
  position - - Update the size or location of the note in the work session
  pin - - Pin or unpin the note
  stroke - - Add a pen or eraser stroke on top of the image
```

### Ephemeral Event

Ephemeral events or volatile events not recorded in the undo/playback event stream, so they're good for in-progress streaming events like dragging a card around the screen, and once the user lifts their finger, a HistoryEvent is used to record its final place.

```
// server <--> client[client-id, “ve”, target-id, event-type, event-properties]
  client-id - - (string) the ID of the originating client
  target-id - - (string) the ID of the target window to which this event is
  relevant
  event-type - - (string) an arbitrary event type
  properties - - (object) a JSON object describing pertinent key / values
  for the event.
```

A spatial event map can include a log of events having entries for history events, where each entry comprises a structure, such as illustrated in FIG. 6A. The server-side network node includes logic to receive messages carrying ephemeral and history events from client-side network nodes, and to send the ephemeral events to other client-side network nodes without adding corresponding entries in the log, and to send history events to the other client-side network nodes while adding corresponding entries to the log. The entries in the log of events can include information about participants such as participant_ID, participant_name, etc. as shown in FIG. 6G.

The entries in the log of events can also include information about the digital displays such as display code, location, etc. as shown in FIG. 6B. A display array data structure, such as that illustrated in FIG. 6H stores information about a plurality of displays used to display content of a workspace in a collaboration. The data structure is used to map the workspace to a plurality of displays in the display arrays. Such display arrays can be used in large meeting rooms or for presentations in large lecture halls, etc.

The entries in the log of events can also include information about canvases such as canvas_ID, canvase_boundary_ID, is_canvas_locked, etc. as shown in FIG. 6C. The entries in the log of events can further include information. The canvas data structure can include a canvas_code that is used for mapping the content received from the physical whiteboard to a target workspace. The workspace may include only one canvas or in some cases the workspace can include a plurality of canvases. In such cases, the canvas_code is used to map the content from the physical whiteboard to a target canvas within the workspace. The canvas data structure may also include an “is canvas locked” Boolean data indicating whether the contents or digital assets in the canvas are visible to participants or locked and not visible to participants in the collaboration meeting.

FIG. 6D presents a canvas boundary data structure which can include attributes that define the boundary of a canvas. The canvas boundary data structure includes a canvas boundary identifier, CX offset, CY offset and CZ offset (for three dimensional canvases). The offsets can indicate the positions of the canvas within the workspace. The canvas boundary data structure can also include width, height, and depth (for three dimensional canvases) attributes for the canvas.

The system can also include a card data structure, such as that illustrated in FIG. 6E. The card data structure can provide a cache of attributes that identify current state information for an object in the workspace data, including a session identifier, a card type identifier, an array identifier, the client identifier, dimensions of the cards, type of file associated with the card, and a session location within the workspace.

The system can include a chunk data structure, such as that illustrated in FIG. 6F, which consolidates a number of events and objects into a catchable set called a chunk. The data structure includes a session ID, and identifier of the events included in the chunk, and a timestamp at which the chunk was created.

The system can include a data structure for links to a user participating in a session in a chosen workspace. This data structure can include a session access token, the client identifier for the session display client, the user identifier linked to the display client, a parameter indicating the last time that a user accessed a session, and expiration time and a cookie for carrying various information about the session. This information can, for example, maintain a current location within the workspace for a user, which can be used each time that a user logs in to determine the workspace data to display at a display client to which the login is associated. A user session can also be linked to a meeting. One or more than one user can participate in a meeting. A user session data structure can identify the meeting in which a user participated in during a given collaboration session. Linking a user session to a meeting enables the technology disclosed to determine the identification of the users and the number of users who participated in the meeting.

The system can include a display array data structure which can be used in association with large-format displays that are implemented by federated displays, each having a display client. The display clients in such federated displays cooperate to act as a single display. The workspace data can maintain the display array data structure which identifies the array of displays by an array ID, and identifies the session position of each display. Each session position can include an x-offset and a y-offset within the area of the federated displays, a session identifier, and a depth.

### Computer System for Binding a Physical Whiteboard to Digital Whiteboards

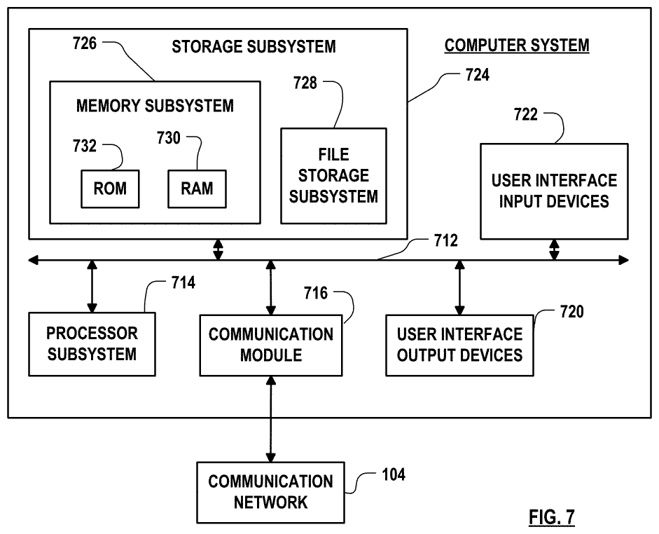

FIG. 7 is a simplified block diagram of a computer system, or network node, which can be used to implement the client-side functions (e.g., computer system 110) or the server-side functions (e.g., server 107) in a distributed collaboration system. A computer system typically includes a processor subsystem 714 which communicates with a number of peripheral devices via bus subsystem 712. These peripheral devices may include a storage subsystem 724, comprising a memory subsystem 726 and a file storage subsystem 728, user interface input devices 722, user interface output devices 720, and a communication module 716. The input and output devices allow user interaction with the computer system. Communication module 716 provides physical and communication protocol support for interfaces to outside networks, including an interface to communication network 104, and is coupled via communication network 104 to corresponding communication modules in other computer systems. Communication network 104 may comprise many interconnected computer systems and communication links. These communication links may be wireline links, optical links, wireless links, or any other mechanisms for communication of information, but typically it is an IP-based communication network, at least at its extremities. While in one embodiment, communication network 104 is the Internet, in other embodiments, communication network 104 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 722 may include a keyboard, pointing devices such as a mouse, trackball, touchpad, or graphics tablet, a scanner, a touch screen incorporated into the display (including the touch sensitive portions of large format digital display such as 102c to 102e), audio input devices such as voice recognition systems, microphones, and other types of tangible input devices. In general, use of the term “input device” is intended to include all possible types of devices and ways to input information into the computer system or onto computer network 104.

User interface output devices 720 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. In the embodiment of FIGS. 1A and 1B, it includes the display functions of large format digital displays such as 102c to 102e. The display subsystem may also provide non-visual display such as via audio output devices. In general, use of the term “output device” is intended to include all possible types of devices and ways to output information from the computer system to the user or to another machine or computer system.

Storage subsystem 724 stores the basic programming and data constructs that provide the functionality of certain embodiments of the present invention.

The storage subsystem 724 when used for implementation of server-side network-nodes, comprises a product including a non-transitory computer readable medium storing a machine-readable data structure including a spatial event map which locates events in a workspace, wherein the spatial event map includes a log of events, entries in the log having a location of a graphical target of the event in the workspace and a time. Also, the storage subsystem 724 comprises a product including executable instructions for performing the procedures described herein associated with the server-side network node.

The storage subsystem 724 when used for implementation of client-side network-nodes, comprises a product including a non-transitory computer readable medium storing a machine-readable data structure including a spatial event map in the form of a cached copy as explained below, which locates events in a workspace, wherein the spatial event map includes a log of events, entries in the log having a location of a graphical target of the event in the workspace and a time. Also, the storage subsystem 724 comprises a product including executable instructions for performing the procedures described herein associated with the client-side network node.

For example, the various modules implementing the functionality of certain embodiments of the invention may be stored in storage subsystem 724. These software modules are generally executed by processor subsystem 714.

Memory subsystem 726 typically includes a number of memories including a main random-access memory (RAM) 730 for storage of instructions and data during program execution and a read only memory (ROM) 732 in which fixed instructions are stored. File storage subsystem 728 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs and may be stored by file storage subsystem 728. The host memory 726 contains, among other things, computer instructions which, when executed by the processor subsystem 714, cause the computer system to operate or perform functions as described herein. As used herein, processes and software that are said to run in or on “the host” or “the computer,” execute on the processor subsystem 714 in response to computer instructions and data in the host memory subsystem 726 including any other local or remote storage for such instructions and data.

Bus subsystem 712 provides a mechanism for letting the various components and subsystems of a computer system communicate with each other as intended. Although bus subsystem 712 is shown schematically as a single bus, alternative embodiments of the bus subsystem may use multiple busses.

The computer system itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 110 depicted in FIG. 7 is intended only as a specific example for purposes of illustrating the preferred embodiments of the present invention. Many other configurations of the computer system are possible having more or less components than the computer system depicted in FIG. 7. The same components and variations can also make up each of the other devices 102a to 102f in the collaboration environment of FIG. 1A, as well as the collaboration server 107 and databases 108 and 109.

Certain information about the drawing regions active on the digital display 102c are stored in a database accessible to the computer system 110 of the display client. The database can take on many forms in different embodiments, including but not limited to a MongoDB database, an XML database, a relational database or an object-oriented database.

### Client-Side Process for Binding a Physical Whiteboard to Digital Whiteboards

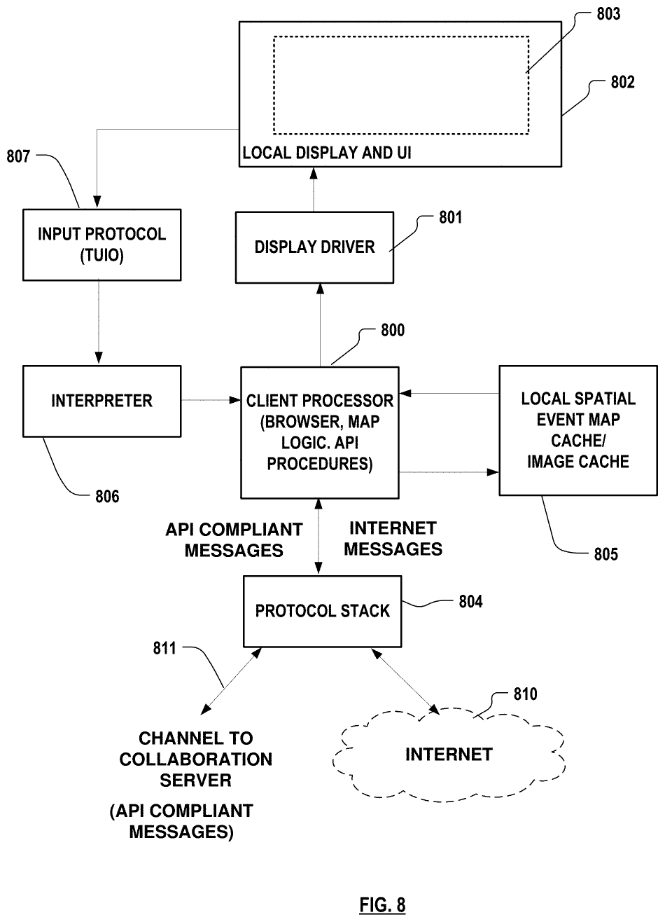

FIG. 8 is a simplified diagram of a client-side network node, including a client processor 800, a display driver 801, a local display and user interface such as a touchscreen 802, a protocol stack 804 including a communication interface controlled by the stack, local memory 805 storing a cache copy of the live spatial event map and a cache of images and other graphical constructs used in rendering the displayable area, and input protocol device 807 which executes a input protocol which translates input from a tangible user input device such as a touchscreen, or a mouse, into a form usable by a command interpreter 806. A suitable input protocol device 807 can include software compatible with a TUIO industry-standard, for example for interpretation of tangible and multi-touch interaction with the display wall. The protocol stack 804 receives API compliant messages and Internet messages from the client processor 800 and as discussed above includes resources to establish a channel 811 to a collaboration server across which API compliant messages can be exchanged, and a link 810 to the Internet in support of other communications that serve the local display 802. The display driver 801 controls a displayable area 803 on the local display 802. The displayable area 803 can be logically configured by the client processor or other programming resources in the client-side network node. Also, the physical size of the displayable area 803 can be fixed for a given implementation of the local display. The client processor 800 can include processing resources such as a browser, mapping logic used for translating between locations on the displayable area 803 and the workspace, and logic to implement API procedures.

The client-side network node (or a client device) shown in FIG. 8 illustrates an example including an application interface including a process to communicate with the server-side network node. The client-side network node shown in FIG. 8 illustrates an example configured according to an API, wherein the events include a first class of event designated as history events to be distributed among other client-side network nodes and to be added to the spatial event log in the server-side network node, and a second class of event designated as ephemeral to be distributed among other client-side network nodes but not added to the spatial event log in the server-side network node.

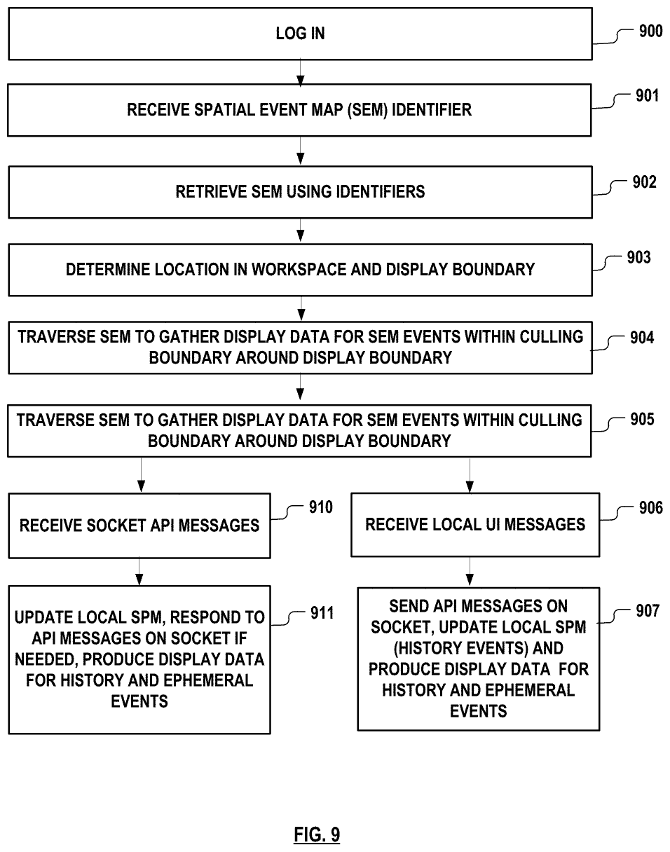

FIG. 9 is a simplified flow diagram of a procedure executed by the client-side network node. The order illustrated in the simplified flow diagram is provided for the purposes of illustration and can be modified as suits a particular implementation. Many of the steps for example, can be executed in parallel. In this procedure, a client login is executed (operation 900) by which the client is given access to a specific collaboration session and its spatial event map. The collaboration server provides an identifier of, or identifiers of parts of, the spatial event map which can be used by the client to retrieve the spatial event map from the collaboration server (operation 901). The client retrieves the spatial event map, or at least portions of it, from the collaboration server using the identifier or identifiers provided (operation 902).

For example, the client can request all history for a given workspace to which it has been granted access as follows:

curl http://localhost:4545/<sessionId>/history

The server will respond with all chunks (each its own section of time):

[“/<sessionId>/history/<startTime>/<endTime>?b=1”]
[“/<sessionId>/history/<startTime>/<endTime>?b=1”]

For each chunk, the client will request the events:

Curl http: //localhost:4545/<sessionId>/history/<startTime>/
<endTime>?b=<cache-buster>

Each responded chunk is an array of events and is cacheable by the client:

```
[
  [
    4,
    ″sx″,
    ″4.4″,
    [537, 650, 536, 649, 536, 648, ...],
    {
        “size″: 10,
        ″color″: [0, 0, 0, 1],
        ”brush”: 1
      },
    1347644106241,
    ″cardFling″
  ]
]
```

The individual messages might include information like position on screen, color, width of stroke, time created etc.

The client then determines a location in the workspace, using for example a server provided focus point, and display boundaries for the local display (operation 903). The local copy of the spatial event map is traversed to gather display data for spatial event map entries that map to the displayable area for the local display. In some embodiments, the client may gather additional data in support of rendering a display for spatial event map entries within a culling boundary defining a region larger than the displayable area for the local display, in order to prepare for supporting predicted user interactions such as zoom and pan within the workspace (operation 904). The client processor executes a process using spatial event map events, ephemeral events and display data to render parts of the spatial event map that fall within the display boundary (operation 905). This process receives local user interface messages, such as from the TUIO driver (operation 906). Also, this process receives socket API messages from the collaboration server (operation 910). In response to local user interface messages, the process can classify inputs as history events and ephemeral events, send API messages on the socket to the collaboration server for both history events and ephemeral events as specified by the API, update the cached portions of the spatial event map with history events, and produce display data for both history events and ephemeral events (operation 907). In response to the socket API messages, the process updates the cached portion of the spatial event map with history events identified by the server-side network node, responds to API messages on the socket as specified by the API, and produce display data for both history events and ephemeral events about which it is notified by the socket messages (operation 911).

Logging in and downloading spatial event map.
1. The client request authorization to join a collaboration session and open a workspace.
2. The server authorizes the client to participate in the session and begin loading the spatial event map for the workspace.
3. The client requests an identification, such as a “table of contents” of the spatial event map associated with the session.
4. Each portion of the spatial event map identified in the table of contents is requested by the client. These portions of the spatial event map together represent the workspace as a linear sequence of events from the beginning of workspace-time to the present. The “beginning of workspace-time” can be considered an elapsed time from the time of initiation of the collaboration session, or an absolute time recorded in association with the session.
5. The client assembles a cached copy of the spatial event map in its local memory.
6. The client displays an appropriate region of the workspace using its spatial event map to determine what is relevant given the current displayable area or viewport on the local display.

Connecting to the session channel of live spatial event map events:
1. After authorization, a client requests to join a workspace channel.
2. The server adds the client to the list of workspace participants to receive updates via the workspace channels.
3. The client receives live messages from the workspace that carry both history events and ephemeral events, and a communication paradigm like a chat room. For example, a sequence of ephemeral events, and a history event can be associated with moving object in the spatial event map to a new location in the spatial event map.
4. The client reacts to live messages from the server-side network node by altering its local copy of the spatial event map and re-rendering its local display.
5. Live messages consist of “history” events which are to be persisted as undue-double, recorded events in the spatial event map, and “ephemeral” events which are pieces of information that do not become part of the history of the session.
6. When a client creates, modifies, moves or deletes an object by interaction with its local display, a new event is created by the client-side network node and sent across the workspace channel to the server-side network node. The server-side network node saves history events in the spatial event map for the session and distributes both history events and ephemeral events to all active clients in the session.
7. When exiting the session, the client disconnects from the workspace channel.

The technology disclosed includes logic to bind a physical whiteboard (or a paper, a poster, etc.) to a digital whiteboard to enable collaboration between participants of a collaboration meeting even when some participants do not have access to a digital whiteboard. The technology disclosed includes a system, including a server device and one or more client devices, comprising logic to take content from a physical whiteboard or a paper and automatically process the content to display it on a canvas on a digital whiteboard. The image of the content on the physical whiteboard can be captured by a camera, scanner, etc. of a client device. The client device can also capture a code that is on the physical whiteboard. The code can be used to identify a particular canvas of a digital whiteboard. The technology disclosed includes logic, which resides on a server device or the client device, to convert content captured from a physical whiteboard to digital format in editable representation. The editable representation can be rendered on the client device after the content (image) is captured. The editable representation can also be rendered on other client devices that have access to a digital whiteboard for collaboration. Along with receiving the captured content (image), the server device of the system can receive the code and it can identify the canvas linked to the code. The server device can include logic to apply mapping to map the editable representation of the captured content captured from the physical whiteboard to the canvas linked to the code. The mapping ensures that content captured from different sizes of physical whiteboards, papers, posters, etc. fits to a portion of the canvas on a digital whiteboard. Similarly, when content from digital whiteboard is moved to the canvas that is linked to the physical whiteboard, the system includes logic to apply mapping so that the content fits on a target physical whiteboard, paper or poster, etc. The server device, after obtaining the editable representation, can add the editable representation to the canvas of a workspace, as accessed by one or more digital whiteboards participating in the collaboration. Further, the server device can allow edits to be made to the editable representation of the image, as located in the canvas. The edits can be received/viewed by participants of the collaboration via one or more digital whiteboards connected to, for example, other client devices. Further, the server device can send the edited editable representation of the image, as an edited image, back to the client device (which is not a digital whiteboard). The client device or the servicer device can cause the edited image to be printed (or displayed on a device) along with the code or the updated code. The participant who was using the physical whiteboard can now use the newly printed and edited image to make further edits and the above-described process can be performed all over again (e.g., the capturing, the converting, the identifying, the adding of the image to the canvas, the allowing of the editing of the image, the sending of the edited image to the client device and the printing can be performed again). This cycle can continue until the collaboration is completed.

For example, the client can request all history for a given workspace to which it has been granted access as follows:

curl http://localhost:4545/<sessionId>/history

The server will respond with all chunks (each its own section of time):

[“/<sessionId>/history/<startTime>/<endTime>?b=1”]
[“/<sessionId>/history/<startTime>/<endTime>?b=1”]

For each chunk, the client will request the events:

Curl http: //localhost:4545/<sessionId>/history/<startTime>/
<endTime>?b=<cache-buster>

Each responded chunk is an array of events and is cacheable by the client:

```
[
  [
    4,
      ″sx″,
        ″4.4″,
        [537, 650, 536, 649, 536, 648, ...],
      {
            “size″: 10,
            ″color″: [0, 0, 0, 1],
            ”brush”: 1
          },
        1347644106241,
        ″cardFling″
      ]
]
```

The individual messages might include information like position on screen, color, width of stroke, time created etc.

The client then determines a viewport in the workspace, using for example a server provided focus point, and display boundaries for the local display. The client-side node (network node) includes logic to traverse spatial event map (SEM) to gather display data (operation 907). The local copy of the spatial event map is traversed to gather display data for spatial event map entries that map to the displayable area for the local display. At this operation the system traverses spatial event map to gather display data that identifies graphical objects (or digital assets). In some embodiments, the client may gather additional data in support of rendering a display for spatial event map entries within a culling boundary defining a region larger than the displayable area for the local display, in order to prepare for supporting predicted user interactions such as zoom and pan within the workspace. The display data can include canvas attached to the whiteboarding session. This data can also include coordinates indicating the boundary of the canvas.

The client-side network node can receive socket API messages (operation 911). The client-side node can receive local user interface messages (operation 913). Also, the client-side node receives socket API messages from the collaboration server. In response to local user interface messages, the client-side node can classify inputs as history events and ephemeral events, send API messages on the socket to the collaboration server for both history events and ephemeral events as specified by the API, the API message can include authorization requests, update the cached portions of the spatial event map with history events, and produce display data for both history events and ephemeral events. In response to the socket API messages, the client-side node can update the cached portion of the spatial event map with history events identified by the server-side network node, responds to API messages on the socket as specified by the API, the API message can include approval events including authorization from content owner account, and produce display data for both history events and ephemeral events about which it is notified by the socket messages.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present technology may consist of any such feature or combination of features. In view of the foregoing description, it will be evident to a person skilled in the art that various modifications may be made within the scope of the technology.

The foregoing description of preferred embodiments of the present technology has been provided for the purposes of illustration and description. It is not intended to be exhaustive or to limit the technology to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology. In addition, any and all variations described, suggested or incorporated by reference herein with respect to any one embodiment are also to be considered taught with respect to all other embodiments. The embodiments described herein were chosen and described in order to best explain the principles of the technology and its practical application, thereby enabling others skilled in the art to understand the technology for various embodiments and with various modifications as are suited to the particular use contemplated. It is intended that the scope of the technology be defined by the following claims and their equivalents.

What is claimed is:

1. A method for collaborating using a virtual workspace, the method including:
obtaining, by a client device, an image, including a code, of at least a portion of a physical whiteboard;
converting, by at least one of the client device and a server device, at least a portion of the image to an editable representation;
identifying, by the server device, a virtual workspace, linked to the code;
adding, by the server device, the editable representation of the portion of image to the virtual workspace to be provided to one or more client devices participating in the collaboration;
allowing, by the server device, an edit to the editable representation of the portion of the image, as located in the virtual workspace, the edit being performed by a particular participant using a particular client device and the edit being received by one or more client devices participating in the collaboration; and
sending, by the server device, the edited editable representation of the portion of the image, as an edited image, to the client device, which does not have access to directly collaborate on the virtual workspace, along with at least one of the code and an updated code.

2. The method of claim 1, further comprising printing, according to an instruction from at least one of the client device and the server device, the edited image along with the at least one of the code and the updated code.

3. The method of claim 1, further comprising the client device rendering the edited image along with the at least one of the code and the updated code.

4. The method of claim 1, wherein the physical whiteboard is a physical medium on which a user can interact with.

5. The method of claim 1, wherein the physical whiteboard is an electronic medium on which a user can interact with.

6. The method of claim 1, wherein the virtual workspace includes multiple canvases a canvas of the multiple canvases is identified in dependence upon the code.

7. The method of claim 1, further including:
mapping, by the server device, the editable representation of the portion of the image obtained from the physical whiteboard to the virtual workspace linked to the code, such that the mapped editable representation of the portion of the image fits within an area within the virtual workspace.

8. The method of claim 1, wherein the code is a Quick Response (or QR) code.

9. The method of claim 1, wherein the code is a bar code.

10. The method of claim 1, wherein the code is an alphanumeric string of a pre-defined length.

11. The method of claim 1, wherein the code is created by a user of the client device and is associated with the virtual workspace in dependence upon at least one of a selection made by the user and the server device.

12. The method of claim 1, wherein the code is an annotation.

13. The method of claim 1, wherein the code is located at a predefined location on the physical whiteboard.

14. The method of claim 1, further including:
detecting, by the server device, a conflict when an edit to the editable representation, as performed by the particular participant, conflicts with an edit made on the physical whiteboard by another participant; and
sending, by the server device, a message to the particular participant and the other participant indicating the conflict.

15. The method of claim 14, further including:
separately storing, by the server device and as conflicted images, both (i) the editable representation, as edited by the particular participant and (ii) an editable representation as converted from an image obtained from the client device and as edited by the other participant; and
updating the virtual workspace linked to the code with a separate editable representation of each of the conflicted images.

16. The method of claim 14, further including:
identifying, by the server device, the edits causing the conflict and sending a representation of the identified edits to the particular participant and the other participant.

17. The method of claim 1, wherein the code is mapped to a uniform resource locator (or URL) identifying a location at which the virtual workspace linked to the code can be accessed.

18. A system including one or more processors coupled to memory, the memory loaded with computer instructions to perform collaborating using a virtual workspace, the instructions, when executed on the processors, implement actions comprising:
obtaining, by a client device, an image, including a code, of at least a portion of a physical whiteboard;
converting, by at least one of the client device and a server device, at least a portion of the image to an editable representation;
identifying, by the server device, a virtual workspace, linked to the code;
adding, by the server device, the editable representation of the portion of image to the virtual workspace to be provided to one or more client devices participating in the collaboration;
allowing, by the server device, an edit to the editable representation of the portion of the image, as located in the virtual workspace, the edit being performed by a particular participant using a particular client device and the edit being received by one or more client devices participating in the collaboration; and
sending, by the server device, the edited editable representation of the portion of the image, as an edited image, to the client device, which does not have access to directly collaborate on the virtual workspace, along with at least one of the code and an updated code.

19. The system of claim 18, further implementing actions comprising:
mapping, by the server device, the editable representation of the portion of the image obtained from the physical whiteboard to the virtual workspace linked to the code, such that the mapped editable representation of the portion of the image fits within an area within the virtual workspace.

20. A non-transitory computer readable storage medium impressed with computer program instructions to perform collaboration, the instructions, when executed on a processor, implement a method comprising:
obtaining, by a client device, an image, including a code, of at least a portion of a physical whiteboard;
converting, by at least one of the client device and a server device, at least a portion of the image to an editable representation;
identifying, by the server device, a virtual workspace, linked to the code;
adding, by the server device, the editable representation of the portion of image to the virtual workspace to be provided to one or more client devices participating in the collaboration;
allowing, by the server device, an edit to the editable representation of the portion of the image, as located in the virtual workspace, the edit being performed by a particular participant using a particular client device and the edit being received by one or more client devices participating in the collaboration; and
sending, by the server device, the edited editable representation of the portion of the image, as an edited image, to the client device, which does not have access to directly collaborate on the virtual workspace, along with at least one of the code and an updated code.
